(19) United States
(12) Patent Application Publication
(10) Pub. No.: US 2006/0099478 A1
(43) Pub. Date: May 11, 2006

(54) Line system for fluids and gases in a fuel cell

(75) Inventors: Guido Schmitz, Dulmen (DE); Harald Hager, Freigericht (DE); Hans Ries, Marl (DE); Olivier Farges, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/246,206

(22) Filed: Oct. 11, 2005

(30) Foreign Application Priority Data
Oct. 11, 2004 (DE) 10 2004 049 653.6

(51) Int. Cl. H01M 8/02; B32B 27/34; B32B 27/32; B32B 27/08

(52) U.S. Cl. 429/34; 428/474.7; 428/476.9

(57) ABSTRACT

An element of a line system of a fuel cell, in which the part which is in contact with the medium being conveyed comprises a polyamide molding composition and, in addition, at least one further layer selected from among: a) a layer II of a further polyamide molding composition; b) a layer III of a molding composition comprising a functionalized polyolefin; c) a layer IV of a polyolefin molding composition in which the polyolefin is not functionalized; and d) a layer V of an EVOH molding composition, is present, can be produced inexpensively and has a good barrier action against the medium being conveyed.

### CROSS REFERENCE TO RELATED APPLICATIONS

This application is based on and claims the benefit of priority of German Patent Application 102004049653.6, filed Oct. 11, 2004, which is hereby incorporated by reference in its entirety.

### BACKGROUND OF THE INVENTION

1. Field of the Invention

The invention relates to an element of a line system of a fuel cell, which comes into contact with fluids and gases.

2. Discussion of the Background

Ever stricter environmental legislation is forcing the manufacturers of motor vehicles to contemplate new engine designs, since legislators are focusing ever more strongly on emissions, specifically NOₓ emissions. The fuel cell represents a possible alternative engine design.

Fuel cells in a multitude of embodiments have long been prior art. In all of them, a fuel is fed into the anode space and air or oxygen is fed into the cathode space. These reactants are reacted catalytically at the electrodes. Hydrogen, methanol, glycol, methane, butane, higher hydrocarbons, etc., can be used as fuel, but only the first makes it possible to achieve current densities which are sufficiently high for a fuel cell operating at approximately room temperature to be able to be used for powering a motor vehicle. The other fuels can be reacted satisfactorily only in a medium- or high-temperature fuel cell, but this is a possibility first and foremost for stationary units. In a motor vehicle having an electric drive system which draws its power from a fuel cell unit which is to be operated using methanol or hydrocarbons, the fuel is therefore usually converted into hydrogen and carbon dioxide by means of steam at elevated temperature in a reformer, the reaction gas is freed of the by-product carbon monoxide and the hydrogen/CO₂ mixture is fed into the anode space. At present, the “proton exchange membrane fuel cell” in which a water-saturated acidic ion-exchange membrane is located between the porous, catalyst-containing electrodes is favored for this purpose. However, work on the direct oxidation of methanol, which would make a reformer superfluous, is being carried out for mobile applications, too.

The lines for the supply of fuel have hitherto usually been made of stainless steel. However, such lines are expensive.

JP 2002-213659 A discloses lines for hydrogen which comprise a polyolefin inner layer, an EVOH intermediate layer and a polyamide outer layer. The problem of the generally unsatisfactory adhesion between such layers has been partly recognized there in that the use of an adhesive, which is not specified in more detail, is addressed.

### SUMMARY OF THE INVENTION

It is an object of the invention to provide an element of a line system of a fuel cell which has an improved barrier action against hydrocarbons, alcohols and hydrogen and in which, in addition, the individual layers themselves adhere firmly to one another.

In addition, it should be made absolutely certain that very substantially no components which can react with the electrolyte or the anode material are leached from the material of the line system in order to prevent poisoning of the catalyst or undesirable polarization.

This object is achieved by an element of a line system of a fuel cell, in which
the innermost layer I which is in contact with the medium being conveyed comprises a polyamide molding composition, and
in addition at least one further layer selected from the group consisting of:
a) a layer II of a further polyamide molding composition;
b) a layer III of a molding composition comprising a functionalized polyolefin;
c) a layer IV of a polyolefin molding composition in which the polyolefin is not functionalized; and
d) a layer V of an EVOH molding composition, is present.

### DETAILED DESCRIPTION OF THE INVENTION

It has been surprisingly found that an element of a line system of fuel cell, which has improved barrier action, can be realized by the present invention.

Such elements are, for example, a pipe or a tubular molding which can be a multilayer pipe in which the innermost layer comprises the polyamide molding composition. Such a pipe or tubular molding can either be produced as a smooth pipe which may, if desired, subsequently be thermoformed, or as a corrugated pipe. Mention may also be made of components in which fluids are stored, for instance storage containers. Further elements are, for example, connecting elements, for instance quick connectors, adapters, filters, components of pumps or components of valves.

The elements of the invention can be produced by means of the customary processes for plastics processing, for example by means of coextrusion (e.g. multilayer pipe), blowmolding or special forms thereof, e.g., suction blowmolding or 3D parison manipulation, in which the preform is coextruded, injection molding and special modifications thereof, e.g. the fluid injection technique, or rotational sintering.

The element of the invention can, for example, have the following layer structure, from the outside inward:

II/I

II/bonding agent/I

III/II/bonding agent/I

IV/II/II/bonding agent/I

IV/bonding agent/I

II/V/II/bonding agent/II

II/III/V/III/II/bonding agent/I

III/I

II/III/I

IV/III/I

IV/III/V/III/I

II/V/bonding agent/I

Suitable polyamides are known to those skilled in the art and many types are commercially available. For example, it is possible to use PA46, PA66, PA68, PA610, PA612, PA88, PA810, PA1010, PA1012, PA1212, PA6, PA7, PA8, PA9, PA10, PA11, PA12, copolyamides based thereon, branched polyamine-polyamide copolymers and mixtures thereof. The designation of the polyamides corresponds to the international standard, where the first digit(s) indicates the number of carbon atoms in the starting diamine and the last digit(s) indicates the number of carbon atoms of the dicarboxylic acid. If only one number is given, this means that the polyamide has been prepared from an α,ω-aminocarboxylic acid or from the lactam derived therefrom.

Suitable homopolyamides and copolyamides, and also suitable polyamine-polyamide copolymers, as well as the aforementioned polyamides, are described in US-A-2002/142118 and U.S. Pat. No. 6,794,048, the disclosures of which are hereby expressly incorporated by reference.

The polyamide molding compositions can contain a maximum of about 50% by weight of additives selected from among impact-modifying rubber and/or customary auxiliaries and additives.

Impact-modifying rubbers for polyamide molding compositions are prior art. They contain functional groups derived from unsaturated functional compounds which have either been copolymerized into the main chain or been grafted onto the main chain. The most widely used impact-modifying rubber is ethylenepropylene rubber (EPM) or ethylene-propylenediene rubber (EPDM) rubber onto which maleic anhydride has been grafted by a free-radical mechanism. Such rubbers can also be used together with an unfunctionalized polyolefin such as isotactic polypropylene, as described in EP-A-0 683 210.

In addition, the molding compositions can further comprise small amounts of auxiliaries or additives which are needed to obtain particular properties. Examples are pigments or fillers such as carbon black, titanium dioxide, zinc sulfide, silicates such as intercalated or exfoliated layer silicates or carbonates, processing aids such as waxes, zinc stearate or calcium stearate, flame retardants such as magnesium hydroxide, aluminium hydroxide or melamine cyanurate, glass fibers, antioxidants, UV stabilizers and also additives which impart to the product antielectrostatic properties or electrical conductivity, e.g. carbon fibers, graphite fibrils, stainless steel fibers or conductive carbon black. The latter is preferably the case for the molding composition of the layer I.

In one possible embodiment, the molding compositions comprise from 1 to 25% by weight of plasticizer, particularly preferably from 2 to 20% by weight and very particularly preferably from 3 to 15% by weight. The amount of plasticizers includes all values and subvalues therebetween, especially including 2, 3, 4, 5, 7, 9, 11, 13, 15, 17, 19, 21 and 23% by weight.

Plasticizers and their use in polyamides are known. A general overview of plasticizers which are suitable for polyamides may be found in Gächter/Müller, Kunststoffadditive, C. Hanser Verlag, 2nd Edition, p. 296.

Customary compounds suitable as plasticizers are, for example, esters of p-hydroxybenzoic acid having from 2 to 20 carbon atoms in the alcohol component or amides of arylsulfonic acids having from 2 to 12 carbon atoms in the amine component, preferably amides of benzenesulfonic acid.

In a preferred embodiment, the molding composition of the layer II, but not the molding composition of the layer I, comprises a plasticizer.

Possible plasticizers are, inter alia, ethyl p-hydroxybenzoate, octyl p-hydroxybenzoate, i-hexadecyl p-hydroxybenzoate, N-n-octyltoluenesulfonamide, N-n-butylbenzenesulfonamide and N-2-ethylhexylbenzenesulfonamide.

The polyolefin of the layers III or IV is, for example, polyethylene or polypropylene. It is in principle possible to use any commercial type. Examples of possible polyolefins are: linear polyethylene of high, medium or low density, LDPE, isotactic or atactic homopolypropylene, random copolymers of propene with ethene and/or 1-butene, ethylene-propylene block copolymers and the like. The polyolefin can further comprise an impact-modifying component such as EPM or EPDM rubber or SEBS. In addition, the customary auxiliaries and additives may be present. The polyolefin can be prepared by any known process, for example by the Ziegler-Natta process, by the Phillips process, by means of metallocenes or by a free-radical mechanism.

The molding composition of the layer IV can be crosslinked according to the prior art so as to achieve an improvement in the mechanical properties, e.g., the low-temperature impact toughness, the heat distortion resistance or the tendency to undergo creep, or the permeability. Crosslinking is carried out, for example, by radiation crosslinking or by means of moisture crosslinking of polyolefin molding compositions containing silane groups.

Functional groups which can be present in the polyolefin of layer III are, for example, anhydride groups, N-acyllactam groups, carboxylic acid groups, epoxide groups, oxazoline groups, trialkoxysilane groups or hydroxyl groups. The functional groups can be introduced in this case either by copolymerization of a suitable monomer together with the olefin or by means of a grafting reaction. In the grafting reaction, a previously produced polyolefin is reacted in a known manner with an unsaturated, functional monomer and advantageously a free-radical donor at elevated temperature.

EVOH has been known for a long time. It is a copolymer of ethylene and vinyl alcohol and is sometimes also referred to as EVAL. The ethylene content of the copolymer is generally from 25 to 60 mol %, in particular from 28 to 45 mol %. Many types are commercially available. For example, reference may be made to the company brochure “Introduction to Kuraray EVAL™ Resins”, Version 1.2/9810, from Kuraray EVAL Europe.

The EVOH is generally prepared by hydrolysis of ethylene-vinyl acetate copolymers. For reasons of improved processibility, it is also possible, according to the invention, to use a partially hydrolyzed ethylene-vinyl acetate copolymer in which the hydrolysis has been carried out to an extent of at least 60%, preferably to an extent of at least 80% and particularly preferably to an extent of at least 90%. Improved processibility can also be achieved by blending in of polyvinyl acetate, ethylene-polyvinyl acetate copolymers or polyamides. In addition, the EVOH molding composition can comprise all further additives known from the prior art, for example sheet silicates. The proportion of EVOH in the molding composition should be at least 50% by weight, preferably at least 60% by weight, particularly preferably at least 75% by weight and very particularly preferably at least 90% by weight.

Suitable bonding agents for joining the layer I to a layer II are, for example, known from U.S. Pat. No. 6,783,821, whose disclosure is expressly incorporated by reference.

Suitable bonding agents for joining the layer I to a layer IV are, for example, blends of polyamide and polyolefin or functionalized polyolefin, if appropriate with addition of a compatibilizer such as a polyamine-polyamide copolymer (U.S. Pat. No. 6,794,048).

Suitable bonding agents for joining the layer I to a layer V are, for example, known from US-A-2002/142118, whose disclosure is expressly incorporated by reference.

All of these bonding agents are present as a separate layer which is formed, for example, by means of coextrusion with the remaining layers.

The line system of the invention or its individual elements can be produced inexpensively. Furthermore, it also has a low weight, which is particularly advantageous for mobile use.

The invention also provides a fuel cell system comprising an element according to the invention, for example for the engine of a motor vehicle.

Numerous modifications and variations on the present invention are possible in light of the above teachings. It is, therefore, to be understood that within the scope of the accompanying claims, the invention may be practiced otherwise than as specifically described herein.

What is claimed is:

1. An element of a line system of a fuel cell, wherein the innermost layer I that is in contact with a medium being conveyed, comprising a polyamide molding composition and, in addition, at least one further layer selected from the group consisting of:
a) a layer II of a further polyamide molding composition;
b) a layer III of a molding composition comprising a functionalized polyolefin;
c) a layer IV of a polyolefin molding composition in which the polyolefin is not functionalized; and
d) a layer V of an EVOH molding composition, is present.

2. The element of a line system of a fuel cell according to claim 1, which is a multilayer pipe, a storage container, a connecting element, an adapter, a filter, a component of a pump or a component of a valve.

3. The element of a line system of a fuel cell according to claim 1, wherein the polyamide molding compositions are based on polyamides selected from the group consisting of PA46, PA66, PA68, PA610, PA612, PA88, PA810, PA1010, PA1012, PA1212, PA6, PA7, PA8, PA9, PA10, PA11, PA12, copolyamides based thereon, branched polyamine-polyamide copolymers and mixtures thereof.

4. The element of a line system of a fuel cell according to claim 1, wherein the polyamide molding composition of the layer I has been made antielectrostatic.

5. A fuel cell system comprising an element according to claim 1.

6. A fuel cell system for the engine of a motor vehicle, which comprises an element according to claim 1.
